(19) United States
(12) Patent Application Publication
(10) Pub. No.: US 2006/0072210 A1
(43) Pub. Date: Apr. 6, 2006

(54) Object-lens device for an optical pickup head

(75) Inventor: Ling-Chen Chang, Taipei (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/229,646

(22) Filed: Sep. 20, 2005

(30) Foreign Application Priority Data
Oct. 4, 2004 (TW) 93130041

(51) Int. Cl. G02B 21/02

(52) U.S. Cl. 359/661

(57) ABSTRACT

An object-lens device for an optical pick-up head includes an object lens and an adapting device. The object lens includes a first surface and a second surface, which faces outwardly from the optical pickup head. The adapting device includes a base part for containing the first surface. The base part includes a first circular opening and a second circular opening. The first surface pierces the first circular opening to combine with the base part, and the laser beam emitted by the optical pickup head projects into the first surface through the second circular opening.

This application claims the benefit of Taiwan application Serial No. 93130041, filed Oct. 4, 2004, the subject matter of which is incorporated herein by reference.

### BACKGROUND OF THE INVENTION

1. Field of the Invention

The invention relates to an object-lens device for an optical pickup head, and more particularly to an object-lens device in which the object lens can be protected and the numerical aperture (NA) of the object lens can be adjusted.

2. Description of the Related Art

FIGS. 1A and 1B are a lateral view and a vertical view illustrating the object lens module in a pickup head of a conventional optical disc drive, respectively. Referring to FIGS. 1A and 1B, the object lens module 100 includes an object lens 110 and a lens holder 120. The object lens 110 is used for focusing the laser beam L onto an optical disc 111. The lens holder 120 is used to support the object lens 110. As the laser beam L used by the optical pickup head (not shown in the drawings) develops from red light to blue light, that is, the wave length of the laser beam is becoming shorter and shorter, the working distance (WD) between the optical disc 111 and object lens 11 is also decreased gradually. Therefore, optical disc 111 with greater run-out deviation is very likely to damage the object lens 110 by collision.

In addition, the object lens 110 must have specific NA sizes according to different types of optical disc 111 so as to provide spot (S) image forming with the desired resolution. The resolution is directly proportional to NA so that the optical disc drive can read the data from the optical disc 111. For example, the NA for a general CD is about 0.4˜0.5, the NA for a DVD is 0.6, the NA for a HD-DVD is 0.65, while the NA for a blue-ray disc (BD) with highest data density is 0.85. Thus for the object lens, the higher data density of the reading/writing system is, the more expensive its price is.

In order to protect the object lens 110 from the damage of the optical disc 111, two rubber balls 130 are disposed on the lens holder 120, as shown in FIG. 1B. Because the rubber balls 130 are slightly higher then the object lens 110, the damage caused by the collision between the optical disc 111 and the object lens 110 can be avoided. As shown in FIG. 1A, the lens holder 120 further includes a beam stop 140 used for constraining the effective diameter D of the laser beam L by the central circular opening 142 and providing the desired NA (˜D/2F) accordingly. Here “F” refers to the focal length of the object lens 110.

However, in order to keep the center of gravity of the whole object lens module 100 right in the center of the object lens 110, the two rubber balls 130 must designed and disposed with high requirement of symmetry, thereby increasing difficulty of the manufacturing process. Moreover, in the conventional manufacturing processing, the rubber balls 130 are welded after the object lens 110 is fixed on the lens holder 120 which complicates the manufacturing process and increases manufacturing time.

### SUMMARY OF THE INVENTION

It is therefore an object of the invention to provide an object-lens device for an optical pick-up head. By means of the combination of an adapter with the object lens manufactured into a unity, the dual objectives of protecting the object lens and controlling the NA of object lens can be reached.

It is an object of the invention to provide an object-lens device for an optical pickup head. The object-lens device includes an object lens and an adapting device. The object lens includes a first surface and a second surface. The second surface faces outwardly from the optical pickup head. The adapting device is used to combine with the object lens. The adapting device includes a base part, which is used to contain the first surface. The base part includes a first circular opening and a second circular opening. The first surface pierces the first circular opening to combine with the base part, and the laser beam emitted by the optical pickup head projects into the first surface through the second circular opening.

In an embodiment, the first surface protrudes from the second circular opening. And the second circular opening is used to control the effective diameter of the laser beam. The adapting device may further include a column-shape wall disposed on the base part and surrounding the second surface, and the column-shape wall is higher than the second surface relative to the base part. The column-shape wall, the first circular opening and the second circular opening have the same central axis. And the column-shape wall is integrated with the base part.

It is an object of the invention to provide an optical pickup head that includes an object lens with a first surface and a second surface, an adapting device for combining with the object lens, a lens holder for supporting the adapting device, and a column-shape wall disposed on a base part of the adapting device and surrounding the second surface. The column-shape wall is higher than the second surface relative to the base part and integrated with the base part.

In an embodiment, the base part further includes a first circular opening and a second circular opening. The first surface pierces the first circular opening to combine with the base part, and a laser beam emitted by the optical pickup head projects into the first surface through the second circular opening. The second circular opening is used to control the effective diameter of the laser beam.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is the lateral view illustrating the object lens module of the optical pickup head in a conventional optical disc drive.

FIG. 1B (Prior Art) is a vertical view of the object lens module of the optical pickup head in a conventional optical disc drive.

FIG. 2A is a cross-session view showing the object-lens device of the optical pickup head according to a preferred embodiment of the invention.

FIG. 2B is a top view of the adapter depicted in FIG. 2A.

FIG. 2C is a top view illustrating the object-lens device whose base part is supported by a lens holder.

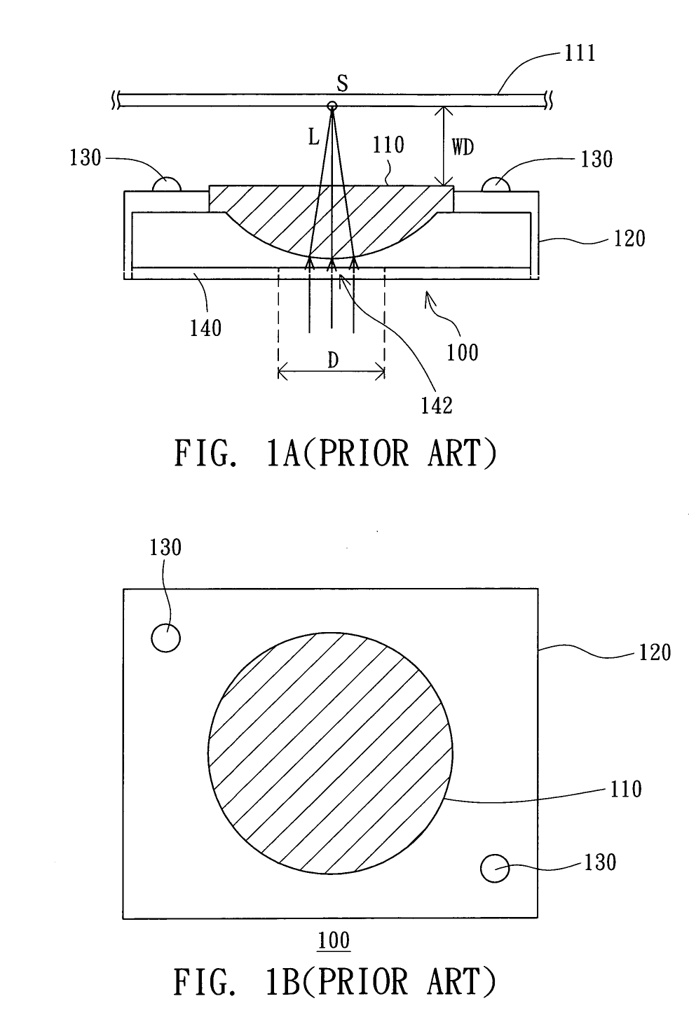

### DETAILED DESCRIPTION OF THE INVENTION

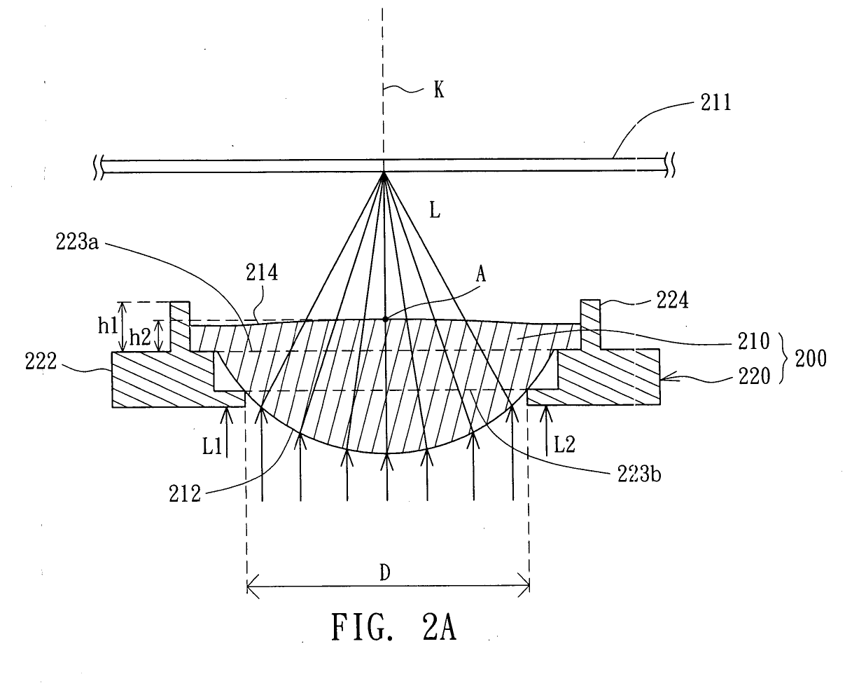

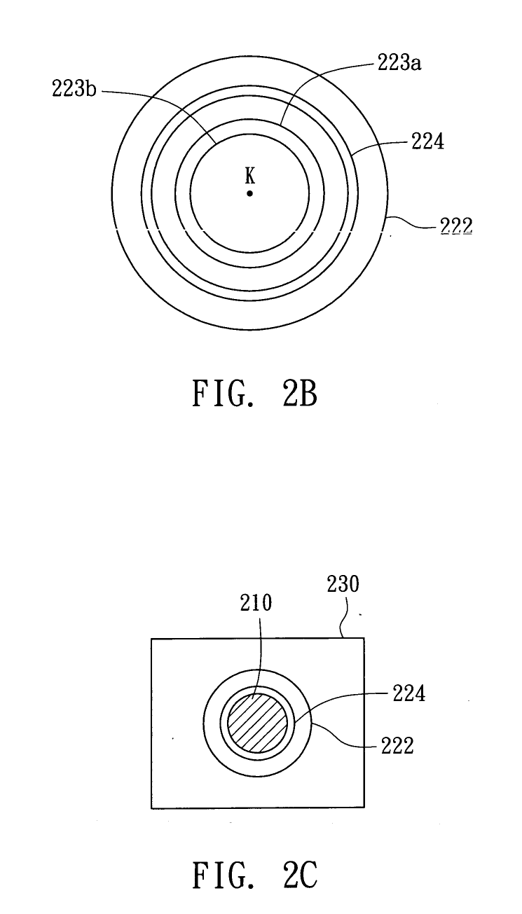

FIG. 2A is a cross-session view of an object-lens device of an optical pickup head according to a preferred embodiment of the invention is shown. FIG. 2B is a top view of the adapter depicted in FIG. 2A. Referring to FIGS. 2A and 2B, the object-lens device is used to focus the laser beam L reflected from a mirror (not shown in the drawings) onto the optical disc 211. The object-lens device 200 includes an object lens 210 and an adapter 220. The object lens 210 includes a first surface 212 and a second surface 214. The first surface 212 is for example a spherical lens, and the second surface 214 faces outwardly from the optical pickup head (not shown in the drawings), namely faces to the optical disc 211. The adapter 220 is used to combine with the object lens 210. The adapter 220 includes a base part 222 and a column-shape ring 224. The base part 222 is used to contain the first surface 212 and the base part 222 includes a first circular opening 223a and a second circular opening 223b as shown in FIG. 2B. The column-shape ring 224 is integrated with base part 222.

The first surface 212 pierces the first circular opening 223a to combine with the base part 222. The first surface 212 protrudes from the second circular opening 223b, and the laser beam L projects into the first surface 212 through the second circular opening 223b. Particularly, the second circular opening 223b is used to control the effective diameter D of the laser beam L. The laser beam L projecting onto the region beyond the second circular opening 223b, for example, the laser beams L1 and L2, will be stopped by the base part 222 from passing the object lens 210 to reach the optical disc 211. Therefore, the effective diameter D of the laser beam L is determined by the diameter of the second circular opening 223b.

In addition, the column-shape ring 224 surrounds and clips the second surface 214. As shown in FIG. 2A, the column-shape ring 224 with a height of h1 relative to the base part 222 is slightly higher then the peak A of the second surface 214 with a height of h2. Accordingly, when the object lens device 200 makes up-down and right-left movement while performing focusing and tracking operation, the column-shape ring 224 can be used to prevent the damage to the object lens 210 caused by the undue run out of the optical disc 211.

Please refer to FIG. 2B and FIG. 2C, a top view illustrating the object-lens device whose base part is supported by a lens holder. It is noted that the center axis of the column-shape ring 212, the center of the first circular opening 223a and the second circular opening 223b fall onto the central axis K, so that the center of gravity of the object lens device 200 could be maintained on the center axis K of the object lens 210. Moreover, as shown in FIG. 2C, the object lens device 200 further includes a lens holder 230 for supporting the base part 222 and moving the object lens 210.

The adapter 220 having the column-shape ring 224 shown in the above description only shows an example in the present invention, and any other adapters with various changes or modifications can be used in the object lens device of the invention. The objectives of protecting the object lens and controlling the NA of object lens can be achieved at the same time as long as the adapter has a cylindrical wall surrounding the second surface 214 of the above-mentioned object lens 210, and has a base part for containing the first surface 212, and the base part includes a circular opening for controlling the effective diameter D of the laser beam L. Therefore, all these modifications will not depart from the scope of the invention.

The advantages of the object-lens device disclosed in the above-mentioned preferred embodiment of the invention are as follows:

1. The adapter is used to protect the object lens and control the NA of object lens in replace of the conventional rubber balls and the beam stop, so the manufacture process can be greatly simplified.

2. The center of gravity of the object lens device can be controlled right at the center of the object lens much easier due to the symmetry structure of the adapter, thereby simplifying the manufacture process.

3. Only the adapter of the optical pickup head has to be replaced yet the same lens holder is used in accordance with different needs of various types of optical discs. Accordingly, the object lens device can be upgraded more easily.

4. The adapter can be designed off-line and then inserted at the appropriate stage of the main-line to complete the manufacture process of the object lens device. Therefore the manufacturing of object lens device is independent to the main-line of the production and hence time spent on the manufacture process is shortened effectively.

While the invention has been described by way of example and in terms of a preferred embodiment, it is to be understood that the invention is not limited thereto. On the contrary, it is intended to cover various modifications and similar arrangements and structures, and the scope of the appended claims should be accorded the broadest interpretation so as to encompass all such modifications and similar arrangements and structures.

What is claimed is:

1. An object-lens device, used in an optical pickup head, comprising:
an object lens, comprising a first surface and a second surface, wherein the second surface faces outwardly from the optical pickup head; and
an adapting device, used for combining with the object lens, the adapting device comprising a base part for containing the first surface, the base part comprising a first circular opening and a second circular opening, wherein the first surface pierces the first circular opening to combine with the base part, and a laser beam emitted by the optical pickup head projects into the first surface through the second circular opening.

2. The object-lens device according to claim 1, wherein the object-lens device further comprises a lens holder for supporting the base part and moving the object lens.

3. The object-lens device according to claim 1, wherein the first surface protrudes from the second circular opening.

4. The object-lens device according to claim 1, wherein the second circular opening is used to control the effective diameter of the laser beam.

5. The object-lens device according to claim 4, wherein the diameter of the second circular opening is the effective diameter of the laser beam.

6. The object-lens device according to claim 1, wherein the adapting device further comprises a column-shape wall disposed on the base part and surrounding the second surface, and the column-shape wall is higher than the second surface relative to the base part.

7. The object-lens device according to claim 6, wherein the column-shape wall is a column-shaped ring.

8. The object-lens device according to claim 6, wherein the second surface is clipped by the column-shape wall.

9. The object-lens device according to claim 6, wherein the column-shape wall, the first circular opening and the second circular opening have the same central axis.

10. The object-lens device according to claim 6, wherein the column-shape wall is integrated with the base part.

11. An optical pickup head comprises:
an object lens, comprising a first surface and a second surface, wherein the second surface faces outwardly from the optical pickup head;
an adapting device, used for combining with the object lens, the adapting device comprising a base part for containing the first surface;
a lens holder for supporting the base part and moving the object lens; and
a column-shape wall disposed on the base part and surrounding the second surface, and the column-shape wall is higher than the second surface relative to the base part;
wherein the column-shape wall is integrated with the base part.

12. The optical pickup head according to claim 11, wherein the column-shape wall is a column-shaped ring.

13. The optical pickup head according to claim 11, wherein the base part further comprising a first circular opening and a second circular opening, wherein the first surface pierces the first circular opening to combine with the base part, and a laser beam emitted by the optical pickup head projects into the first surface through the second circular opening.

14. The optical pickup head according to claim 13, wherein the first surface protrudes from the second circular opening.

15. The optical pickup head according to claim 13, wherein the second circular opening is used to control the effective diameter of the laser beam.

16. The optical pickup head according to claim 15, wherein the diameter of the second circular opening is the effective diameter of the laser beam.

17. The optical pickup head according to claim 13, wherein the second surface is clipped by the column-shape wall.

18. The optical pickup head according to claim 13, wherein the column-shape wall, the first circular opening and the second circular opening have the same central axis.
